(19) United States
(12) Patent Application Publication
(10) Pub. No.: US 2024/0422271 A1
(43) Pub. Date: Dec. 19, 2024

(54) MANAGEMENT SERVER AND IMAGE FORMING DEVICE

(71) Applicant: Toshiba Tec Kabushiki Kaisha, Tokyo (JP)

(72) Inventor: Yoshiki KOGISO, Numazu (JP)

(73) Assignee: Toshiba Tec Kabushiki Kaisha, Tokyo (JP)

(21) Appl. No.: 18/642,791

(22) Filed: Apr. 22, 2024

(30) Foreign Application Priority Data
Jun. 19, 2023 (JP) 2023-100281

(51) Int. Cl. H04N 1/00

(52) U.S. Cl. CPC H04N 1/00344; H04N 1/00244; H04N 2201/0094

(57) ABSTRACT

A management server includes a communication interface, a memory, and a processor. The communication interface communicates with an image forming device including a printer that prints an image on a medium and a reader-writer that writes data to an electronic device provided on the medium, and a reader device that reads the data from the electronic device. The memory stores document management information including job information that represents a job executed using a document whose data is written by the reader-writer to the electronic device provided on the medium on which the image is printed by the printer in the image forming device. The processor updates information that represents a work status of the job represented by the job information in the document management information, based on reading information of the electronic device provided on the document by the reader device.

### CROSS-REFERENCE TO RELATED APPLICATION

This application is based upon and claims the benefit of priority from Japanese Patent Application No. 2023-100281, filed on Jun. 19, 2023, the entire contents of which are incorporated herein by reference.

### FIELD

Embodiments described herein relate generally to a management server and an image forming device.

### BACKGROUND

According to the related art, a method for managing a document via an RFID (Radio Frequency Identification) tag attached to the document is proposed. The document with an RFID tag attached is generated by attaching an RFID tag on which data is separately written, to a sheet on which a written document is printed.

However, in the case of the related-art document with an RFID tag, the printing of a written document onto a sheet and the writing of data onto an RFID tag are carried out by separate devices. This poses a problem in that a wrong RFID may be attached to a printed object. Also, in the related-art management method, the RFID tag attached to the document is used only for the purpose of identifying the document. This poses a problem in that it is not very convenient even if a document with an RFID tag attached is generated.

### DESCRIPTION OF THE DRAWINGS

FIG. 1 shows an example of the configuration of a document management system including a management server and a digital multi-functional peripheral as an image forming device according to an embodiment.

FIG. 2 is an external view showing an example of the configuration of the digital multi-functional peripheral.

FIG. 3 is a cross-sectional view showing an example of the configuration of the digital multi-functional peripheral.

FIG. 4 is a block diagram showing an example of the configuration of a control system in the digital multi-functional peripheral.

FIG. 5 is a block diagram showing an example of the configuration of a control system in the management server.

FIG. 6 shows an example of document management information registered in a memory unit by the management server.

FIG. 7 explains a first application example as an operation example of the document management system.

FIG. 8 explains a second application example as an operation example of the document management system.

FIG. 9 explains a third application example as an operation example of the document management system.

FIG. 10 is a flowchart for explaining an operation example of management processing to a document with an RFID tag by the management server.

### DETAILED DESCRIPTION

At least one embodiment described herein is to provide a management server and an image forming device that can manage various applications using a document generated with a medium having an electronic device.

In general, according to at least one embodiment, a management server includes a communication interface, a memory, and a processor. The communication interface communicates with an image forming device including a printer that prints an image on a medium and a reader-writer that writes data to an electronic device provided on the medium, and a reader device (reader) that reads the data from the electronic device. The memory stores document management information including job information that represents a job executed using a document whose data is written by the reader-writer to the electronic device provided on the medium on which the image is printed by the printer in the image forming device. The processor updates information that represents a work status of the job represented by the job information in the document management information, based on reading information of the electronic device provided on the document by the reader device.

An embodiment will now be described with reference to the drawings.

First, the configuration of a document management system 1 according to the embodiment will be described.

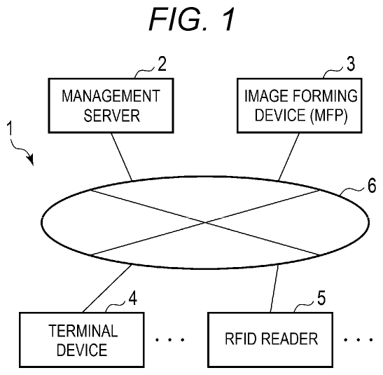

FIG. 1 schematically shows an example of the configuration of the document management system 1 according to the embodiment.

As shown in FIG. 1, the document management system 1 includes a management server 2, a digital multi-functional peripheral (MFP) 3 as an image forming device, a terminal device 4, and an RFID reader 5 or the like.

The management server 2 is formed of a server computer or the like. The management server 2 is communicatively connected to the digital multi-functional peripheral 3, the terminal device 4, and the RFID reader 5 via a network. The management server 2 manages information about a document formed of a medium with an RFID tag generated by the digital multi-functional peripheral 3.

The management server 2 manages information about a job (process) executed using the document generated by the digital multi-functional peripheral 3. The management server 2 manages information that represents the status of execution or the like of the job executed using the document, based on reading information read from the RFID tag on the document by the RFID reader 5. The management server 2 also notifies a user publishing the document or a manager, of information according to the status of the job executed using the document and a time limit or the like set for the document.

The digital multi-functional peripheral 3 is an example of an image forming device placed in a workplace or the like. The digital multi-functional peripheral 3 includes a printer that prints image on a medium, and an RFID reader-writer (RFID device) that writes data to an RFID tag as an electronic device. The digital multi-functional peripheral 3 prints an image on a medium with an RFID tag and writes data to the RFID tag of the medium with the image printed thereon, and thus generates a document. The configuration of the digital multi-functional peripheral 3 will be described in detail later.

The terminal device 4 is an information processing device such as a personal computer (PC) or a portable terminal (tablet terminal or smartphone). The terminal device 4 communicates with the management server 2 via a network 6. In the document management system 1, a plurality of terminal devices 4 may be connected to the network 6. The terminal device 4 includes an information processing device with which the user gives an instruction to generate a document by the digital multi-functional peripheral 3. The terminal device 4 may also include an information processing device connected to the RFID reader 5, described later.

The terminal device 4 has a control circuit including a processor and a memory or the like, a communication interface, an operator, and a display or the like. The communication interface is a communication interface to communicate with a device such as the management server 2 via the network 6. The operator is a device such as a keyboard or a touch panel operated by the user. The display is a reporting device that displays information given by the management server 2. The control circuit executes various processing by the processor executing a program stored in the memory. For example, the control circuit carries out processing of transmitting information (document publishing information) representing a content of a document to be generated that is inputted by the user using the operator, to the management server 2 or the digital multi-functional peripheral 3.

The RFID reader 5 is a device (reader device) that reads data from the RFID tag as an electronic device provided on the medium generated as a document by the digital multi-functional peripheral 3. However, the RFID reader 5 may be formed of a reader-writer having a function of writing data to the RFID tag. The RFID reader 5 notifies the management server 2 of reading information (reading result) including data read from the RFID tag, or the like. A plurality of RFID readers 5 may be provided on the network 6. The RFID reader 5 may be a device connected to the terminal device 4. The RFID reader 5 may also be a handheld device connected to the terminal device 4.

The RFID reader 5 has a control circuit including a processor and a memory or the like, an RFID communicator, and a communication interface for network communication. The RFID communicator is a device that communicates with the RFID tag as an electronic device provided on the document (medium). The RFID communicator in the RFID reader 5 may be any device that reads data from the RFID tag as an electronic device provided on the document. The communication interface for network communication is an interface to communicate with a device such as the management server 2 via the network 6. The control circuit executes various processing by the processor executing a program stored in the memory. For example, the control circuit carries out processing of transmitting reading information (reading result) including data read from the RFID tag, to the management server 2.

The digital multi-functional peripheral 3 as the image forming device according to the embodiment will now be described.

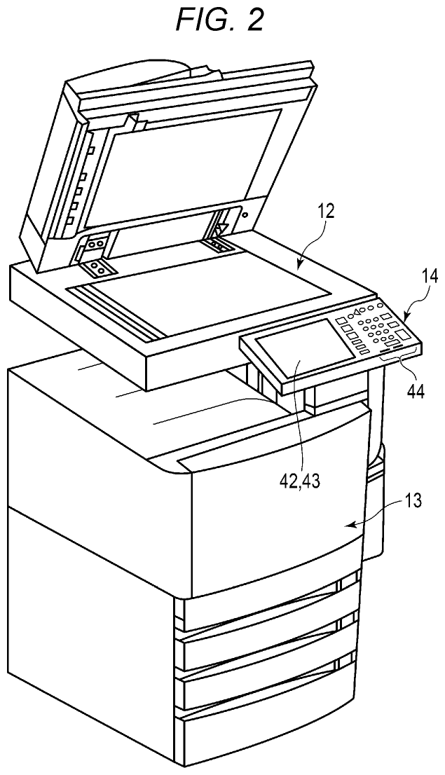

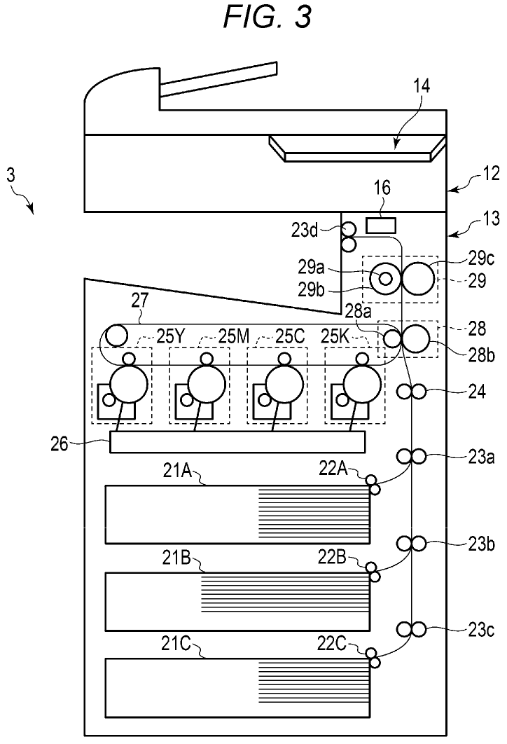

FIG. 2 is a perspective view showing an example of the external configuration of the digital multi-functional peripheral 3 as the image forming device according to the embodiment. FIG. 3 is a cross-sectional view schematically showing an example of the configuration of a control system in the digital multi-functional peripheral 3 as the image forming device according to the embodiment.

As shown in FIG. 2, the digital multi-functional peripheral 3 has a scanner 12, a printer 13, and an operation panel 14. As shown in FIG. 3, the digital multi-functional peripheral 3 has, in the casing thereof, a system control unit 15 and an RFID device 16.

The scanner 12 is installed at an upper part of the main body of the digital multi-functional peripheral 3. The scanner 12 is a device that optically reads an image on a document. The scanner 12 has a document glass table where a document to be scanned is placed. The scanner 12 has an image reading mechanism to scan a document on the document glass table. The image reading mechanism of the scanner 12 is formed of a carriage and a photoelectric conversion unit or the like that are installed below the document glass table. The scanner 12 may also have an auto document feeder (ADF).

The printer (image forming mechanism) 13 has paper feed cassettes 21A, 21B, 21C. The paper feed cassettes 21A, 21B, 21C store a medium such as a sheet to be processed. The medium stored in the paper feed cassettes 21A, 21B, 21C may be any medium that can be conveyed by a conveyance system, described later. For example, the paper feed cassettes 21A, 21B, 21C are attachable to and removable from a lower part of the main body of the digital multi-functional peripheral. The paper feed cassettes 21A, 21B, 21C have paper feed rollers 22A, 22B, 22C, respectively. The paper feed rollers 22A, 22B, 22C pick up sheets one by one from the paper feed cassettes 21A, 21B, 21C. In this embodiment, it is assumed that a plurality of media having an RFID tag are stored in one of the paper feed cassettes 21A, 21B, 21C.

A conveyance system (conveyance mechanism) 23 conveys a medium (hereinafter referred to as a sheet) in the printer 13. The conveyance system 23 includes a plurality of conveyance rollers 23a to 23d and a registration roller 24 or the like. The conveyance system 23 conveys the sheet picked up by the paper feed rollers 22A, 22B, 22C to the registration roller 24. The registration roller 24 conveys the sheet to a transfer position at a timing of transferring an image.

A plurality of image forming units 25 (25Y, 25M, 25C, 25K) form images of corresponding colors (yellow, magenta, cyan, black), respectively. An exposure device 26 forms an electrostatic latent image as an image developed in each color on each image carrier in the image forming units 25 (25Y, 25M, 25C, 25K). The exposure device 26 scans the image carrier with light emitted according to image data and thus forms an electrostatic latent image on the image carrier. For example, the exposure device 26 irradiates a photoconductive drum as an image carrier with light emitted from a light-emitting unit via a polygon mirror rotating the light and thus causes the light to scan the image carrier in a main scanning direction. The position of irradiation with the light from the exposure device 26 moves in a sub scanning direction as the photoconductive drum rotates. The image formed by the image forming unit 25 is adjusted in position and magnification by controlling the exposure device 26.

The image forming units 25 (25Y, 25M, 25C, 25K) develop the electrostatic latent images on the image carriers with toners of the corresponding colors (yellow, magenta, cyan, black), respectively. An intermediate transfer belt 27 is an intermediate transfer body. Each image forming unit 25 transfers the toner image of each color developed with the toner of each color on each image carrier, to the intermediate transfer belt 27 (primary transfer).

The intermediate transfer belt 27 holds the transferred toner image and sends the toner image to a secondary transfer position. The secondary transfer position is a position where the toner image on the intermediate transfer belt 27 is transferred to a sheet. The secondary transfer position is a position where a support roller 28a and a secondary transfer roller 28b face each other. The support roller 28a and the secondary transfer roller 28b form a transfer unit 28. The registration roller 24 conveys a sheet to the secondary transfer position in synchronization with the toner image on the intermediate transfer belt 27. The transfer unit 28 transfers the toner image held on the intermediate transfer belt 27 to the sheet at the secondary transfer position.

For example, in the case of forming a color image, the image forming units 25Y, 25M, 25C, and 25K transfer toner images developed with toners of the corresponding colors (yellow, magenta, cyan, black), respectively, in the state of being superimposed on each other onto the intermediate transfer belt 27. The intermediate transfer belt 27 holds the color image formed of the toner images of the colors superimposed on each other. The transfer unit 28 transfers the color image formed of the toners of the plurality of colors on the intermediate transfer belt 27 to a sheet at the secondary transfer position. The registration roller 24 conveys a sheet to the secondary transfer position at the same timing as the toner images on the intermediate transfer belt 27. Thus, the color image is transferred to the sheet.

The transfer unit 28 supplies the sheet with the toner images transferred thereto, to a fixer 29. The fixer 29 fixes the toner images to the sheet. The fixer 29 has a heating unit 29a, a heat roller 29b, and a pressurizing roller 29c. The heating unit 29a heats the heat roller 29b. The heat roller 29b and the pressurizing roller 29c carry out fixing processing of heating the sheet with the toner images transferred thereto by the transfer unit 28, in a pressurized state. The heat roller 29b and the pressurizing roller 29c of the fixer 29 send the sheet on which the fixing processing is carried out, to the conveyance roller 23d. The conveyance roller 23d conveys the sheet from the fixer 29 to a paper discharge unit.

The operation panel 14 is a user interface. The operation panel 14 displays a guidance and accepts an input on an operation button or an icon. For example, the user inputs setting information at the operation panel 14. The operation panel 14 has a display unit (display) 42, a touch panel 43, and a plurality of operation buttons 44. For example, the touch panel 43 is provided on a display screen of the display unit 42. The touch panel 43 detects a position touched by the user on the display screen of the display unit 42.

The RFID device 16 communicates with an RFID tag as an electronic device provided on a medium that forms a document. The RFID device 16 is a reader-writer that writes data to the RFID tag and reads data written in the RFID tag. The RFID device 16 is installed inside the casing of the digital multi-functional peripheral 3 so as to communicate with the RFID tag provided on the medium conveyed by the conveyance system 23 of the printer 13.

The RFID device 16 writes data to the RFID tag provided on the medium at a predetermined writing position in a conveyance path of the medium by the conveyance system 23. The RFID device 16 reads data written in the RFID tag provided on the medium after passing through the predetermined writing position in the conveyance path. For example, the RFID device 16 controls the radio wave intensity of a carrier wave outputted to the RFID tag and thus sets the size of the communication range.

In the example of the configuration shown in FIG. 3, the RFID device 16 is provided in such a way as to communicate with the RFID tag provided on the medium after an image is printed on the medium. However, the RFID device 16 may have any configuration that can write data to the RFID tag provided on the medium conveyed by the conveyance system 23. The data writing position by the RFID device 16 may be set to any position where data can be written to the RFID tag of the medium conveyed by the conveyance system 23. For example, the data writing position by the RFID device 16 may be a position before an image is formed on the medium, in the conveyance path of the conveyance system 23. The RFID device 16 may also be an external device that is attachable to and removable from an interface provided in the digital multi-functional peripheral 3.

The configuration of the control system in the digital multi-functional peripheral 3 configured as described above will now be described.

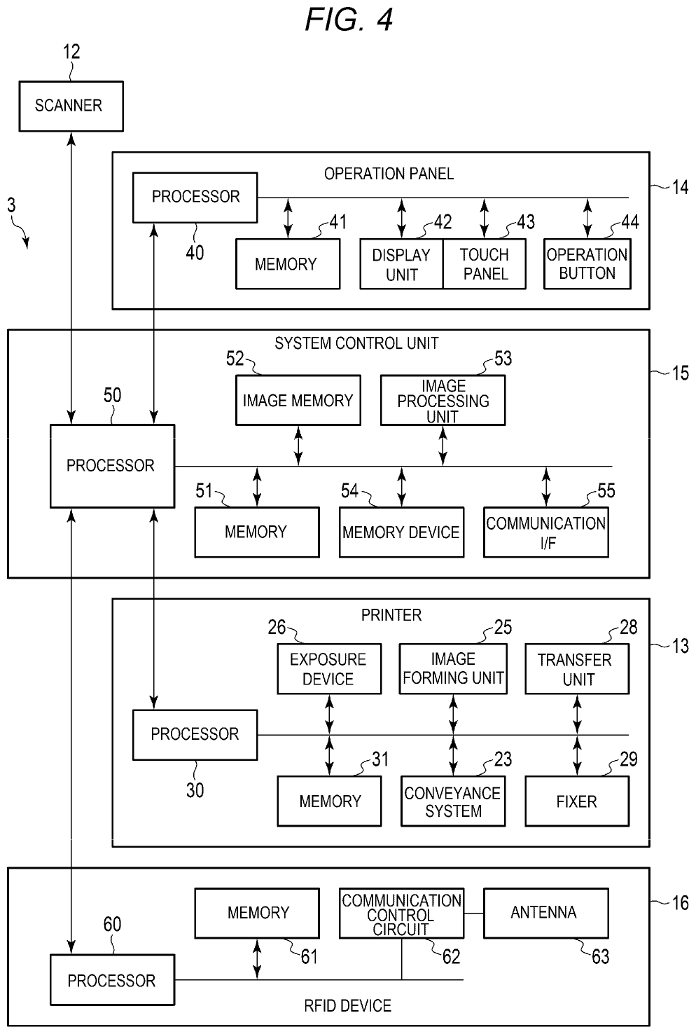

FIG. 4 is a block diagram explaining an example of the configuration of the control system in the digital multi-functional peripheral 3.

The digital multi-functional peripheral 3 has the system control unit 15 controlling the entirety of the device. The system control unit 15 is connected to the scanner 12, the printer 13, the operation panel 14, and the RFID device 16. In the example of the configuration shown in FIG. 4, the system control unit 15 includes a processor 50, a memory 51, an image memory 52, an image processing unit 53, a memory device 54, and a communication interface (I/F) 55 or the like.

The processor 50 is connected to the scanner 12, a processor 30 of the printer 13, a processor 40 of the operation panel 14, and a processor 60 of the RFID device 16 via an interface. The processor 50 executes a program stored in the memory 51 or the memory device 54 and thus implements various processing functions. For example, the processor 50 executes a program stored in the memory 51 and thus outputs an operation instruction to each part or processes various information from each part.

The memory 51 includes a memory such as a RAM (random-access memory), a ROM (read-only memory), or an NVM (non-volatile memory). The RAM functions as a working memory or a buffer memory. The ROM is a non-rewritable non-volatile memory. The ROM functions as a program memory. The NVM is a rewritable non-volatile memory. The NVM stores setting data or the like.

The image memory 52 stores image data. For example, the image memory 52 functions as a page memory to load image data to be processed.

The image processing unit 53 processes image data. The image processing unit 53 outputs, for example, image data formed by performing image processing such as correction, compression or expansion on inputted image data. The image processing unit 53 also has a processor for image processing. The processor for image processing in the image processing unit 53 has a variable operation frequency (operation speed). The image processing unit 53 changes the operation frequency of the processor and thus changes the processing time taken for image processing. For example, the image processing unit 53 overclocks the operation frequency of the processor and thus can set the processing time of image processing so that a processing speed 1.5 times higher or twice higher is achieved.

The memory device 54 stores control data, a control program, and data such as setting information. The memory device 54 is formed of a rewritable non-volatile memory. For example, the memory device 54 is formed of a memory device such as an HDD (hard disk drive) or an SSD (solid-state drive).

The memory device 54 also has a scan counter and a print counter. The scan counter counts the number of pages scanned using the scanner 12. In the digital multi-functional peripheral 3 as an image reading device according to the embodiment, the scan counter counts the number of pages scanned on a per scan speed basis. The print counter counts the number of pages printed using the printer 13. In the digital multi-functional peripheral 3 as the image forming device according to the embodiment, the print counter counts the number of pages printed on a per print speed basis.

The communication I/F 55 is an interface to perform data communication with an external device. For example, the communication I/F 55 is an interface that communicates with an external device as an output destination to which an image scanned by a network scan function is outputted. The communication I/F 55 is also an interface that receives an image to be printed and a print instruction from an external device by a network print function. The communication I/F 55 also includes an interface o transmit facsimile data generated from an image scanned by a facsimile function, to a destination of facsimile transmission. The communication I/F 55 may also be an interface to communicate with an external device (server or the like) that collects the values or the like of the scan counter and the print counter.

An example of the configuration of a control system in the printer 13 will now be described.

As shown in FIG. 4, the printer 13 includes the processor 30, a memory 31, the conveyance system 23, the image forming unit 25, the exposure device 26, the transfer unit 28, and the fixer 29 or the like.

The processor 30 executes a program stored in the memory 31 and thus implements various processing. For example, the processor 30 executes a program and thus performs operation control of each part of the printer 13 and monitoring of the operation status of each part, or the like. Also, the processor 30 is connected to the processor 50 of the system control unit 15 via an interface. The processor 30 executes print processing or the like in response to an operation instruction from the system control unit 15.

The memory 31 includes a memory such as a RAM (random-access memory), a ROM (read-only memory), or a data memory. The RAM functions as a working memory or a buffer memory. The ROM is a non-rewritable non-volatile memory. The ROM functions as a program memory. The data memory is a rewritable non-volatile memory.

The conveyance system 23 conveys a sheet in the printer 13 under the control of the processor 30. That is, the conveyance system 23 drives the conveyance roller at each part in response to an operation instruction from the processor 30 and thus conveys a sheet.

The exposure device 26 irradiates each photoconductive drum of the image forming unit 25 with light (laser light) to form an electrostatic latent image, in response to an operation instruction from the processor 30. The processor 30 controls the position of irradiation with the laser light on the photoconductive drum by the exposure device 26 and thus adjusts the print position and magnification or the like. The processor 30 executes image adjustment to achieve a desired print area by operation control in accordance with a print area having a print reference point, described later, as a starting point.

The image forming unit 25 develops the electrostatic latent image formed on the photoconductive drum with a toner of the corresponding color in response to an operation instruction from the processor 30. The image forming unit 25 also transfers the toner formed on the photoconductive drum to the intermediate transfer belt (primary transfer).

The transfer unit 28 transfers the toner image transferred to the intermediate transfer belt 27 to a sheet in response to an operation instruction from the processor 30 (secondary transfer). The fixer 29 drives the heat roller 29b and the pressurizing roller 29c in response to an operation instruction from the processor 30. The heating unit 29a of the fixer 29 causes the surface temperature of the heat roller 29b to be a desired fixing temperature under the control of the processor 30. The fixer 29 fixes the toner image transferred to the sheet, to the sheet, in the state of being controlled to the fixing temperature.

An example of the configuration of a control system in the operation panel 14 will now be described.

As shown in FIG. 4, the operation panel 14 includes the processor 40, a memory 41, the display unit (display) 42, the touch panel 43, and the operation button 44 or the like.

The processor 40 executes a program stored in the memory 41 and thus implements various processing. For example, the processor 40 executes a program and thus performs operation control of each part of the operation panel 14 and monitoring of the operation status of each part, or the like. Also, the processor 40 is connected to the processor 50 of the system control unit 15 via an interface. For example, the processor 40 notifies the system control unit 15 of information inputted by the user.

The memory 41 includes a memory such as a RAM (random-access memory), a ROM (read-only memory), or a data memory. The RAM functions as a working memory or a buffer memory. The ROM is a non-rewritable non-volatile memory. The ROM functions as a program memory. The data memory is a rewritable non-volatile memory.

The display unit 42 controls the display content in response to an operation instruction from the processor 40. The touch panel 43 is provided on the display screen of the display unit 42 and detects a touched position on the display screen. For example, the processor 40 causes the display unit 42 to display, on the display screen thereof, an operation guidance and an icon that is selectable via the touch panel 43. The processor 40 determines the information inputted by the user in response to the touch position detected by the touch panel 43. The operation button 44 is formed of a hard key such as a start key or a reset key.

An example of the configuration of a control system in the RFID device 16 will now be described.

As shown in FIG. 4, the RFID device 16 includes the processor 60, a memory 61, a communication control circuit 62, and an antenna 63.

The processor 60 executes a program stored in the memory 61 and thus implements various processing. For example, the processor 60 executes a program and thus performs operation control of each part of the RFID device 16. The processor 60 is also connected to the processor 50 of the system control unit 15 via an interface. The processor 60 executes transmission of a command to the RFID tag and processing of a response, or the like, in response to an operation instruction from the system control unit 15.

The memory 61 includes a memory such as a RAM (random-access memory), a ROM (read-only memory), or a data memory. The RAM functions as a working memory or a buffer memory. The ROM is a non-rewritable non-volatile memory. The ROM functions as a program memory. The data memory is a rewritable non-volatile memory.

The communication control circuit 62 processes a signal transmitted and received by the antenna 63. The communication control circuit 62 is connected to the processor 60 and the antenna 63. The communication control circuit 62 includes, for example, a modulation circuit, an amplification circuit, an output setting circuit, and a demodulation circuit or the like.

The antenna 63 transmits and receives a radio wave. The antenna 63 is connected to the communication control circuit 62. The antenna 63 transmits a signal from the communication control circuit 62 as a radio wave. The antenna 63 also supplies a signal received as a radio wave to the communication control circuit 62.

For example, the communication control circuit 62 transmits a signal supplied from the processor, as a radio wave from the antenna 63. The communication control circuit 62 modulates the signal from the processor 60 by the modulation circuit, amplifies the modulated signal by the amplification circuit, and outputs the amplified signal as a radio wave from the antenna 63. Thus, the processor 60 writes data to an RFID tag provided on a medium S at a writing position, based on the output signal outputted from the communication control circuit 62 via the antenna 63.

The communication control circuit 62 also processes a radio wave received by the antenna 63 and supplies the processed radio wave to the processor 60. The communication control circuit 62 amplifies the radio wave signal received by the antenna 63, by the amplification circuit, subsequently demodulates the amplified signal by the demodulation circuit, and supplies the demodulated signal to the processor 60. Thus, the processor 60 checks and reads the data written to the RFID tag provided on the medium S passing through the writing position, using the communication control circuit 62 and the antenna 63.

The configuration of a control system in the management server 2 in the document management system 1 according to the embodiment will now be described.

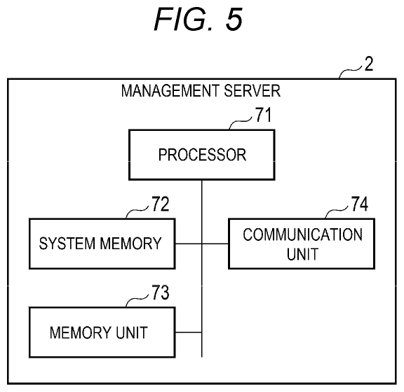

FIG. 5 is a block diagram explaining an example of the configuration of the control system in the management server 2 according to the embodiment.

The management server 2 includes a processor 71, a system memory 72, a memory unit 73, and a communication unit 74 or the like.

The processor 71 is connected to the system memory 72, the memory unit 73, and the communication unit 74. The processor 71 executes a program stored in the system memory 72 or the memory unit 73 and thus implements various processing functions. For example, the processor 71 executes a program stored in the system memory 72 and thus outputs an operation instruction to each part or processes various information from each part.

The system memory 72 includes a memory such as a RAM (random-access memory), a ROM (read-only memory), or an NVM (non-volatile memory). The RAM functions as a working memory or a buffer memory. The ROM is a non-rewritable non-volatile memory. The ROM functions as a program memory. The NVM is a rewritable non-volatile memory. The NVM stores setting data or the like.

The memory unit 73 stores control data, a control program, and data such as setting information. The memory unit 73 is formed of a rewritable non-volatile memory. For example, the memory unit 73 is formed of a memory device such as an HDD (hard disk drive) or an SSD (solid-state drive).

The memory unit 73 is a memory that stores document management information for the document generated by the digital multi-functional peripheral 3. The memory unit 73 records information about the document and information about a job (process) executed using the document, in the document management information. The memory unit 73 updates information that represents work as the job using the document or the work status of processing, in the document management information.

The communication unit 74 is a communication interface to perform data communication with an external device. For example, the communication unit 74 is a communication interface for network communication. In the document management system 1, the communication unit 74 communicates with the digital multi-functional peripheral 3, the terminal device 4, and the RFID reader 5 via the network 6. Also, the communication unit 74 may include an interface to serially connect to the digital multi-functional peripheral 3.

The document management system 1 according to the embodiment may be configured in such a way that the digital multi-functional peripheral 3 includes the foregoing management server 2. For example, the system control unit 15 of the digital multi-functional peripheral 3 may also operate as the foregoing management server 2 in addition to the function of controlling each part of the digital multi-functional peripheral 3 described above. If the system control unit 15 operates as the management server 2, the processor 50, the memory 51, the memory device 54, and the communication I/F 55 shown in FIG. 4 may operate as the processor 71, the system memory 72, the memory unit 73, and the communication unit 74 shown in FIG. 5.

The management of a document that is a medium with an RFID tag in the document management system 1 according to the embodiment will now be described.

In the document management system 1 according to the embodiment, the digital multi-functional peripheral 3 generates a document using a medium having an RFID tag. For example, the user inputs information to be recorded on the document generated by the digital multi-functional peripheral 3 and document publishing information that represents the contents of a series of jobs (work or processing) executed using the document, or the like, to the terminal device 4. The user may also select and designate a job corresponding to the document to be generated, from various jobs registered in the management server 2.

The document publishing information is, for example, information including print data, RFID data, one or a plurality of pieces of job (process) information, and due date or the like.

The print data represents an image to be printed on the medium S with an RFID tag generated as a document. The RFID data represents data to be written to the RFID tag provided on the medium S generated as a document. However, the RFID data may be data allocated by the management server 2 or the digital multi-functional peripheral 3 to the document to be generated.

The job (process) information is information that represents work or processing to be executed using the document. A plurality of pieces of job information may be provided. An order of execution may be designated for the plurality of pieces of job information. Each piece of job information includes information that represents the content of work (processing), information that represents a reader (corresponding reader) to read the RFID tag of the document when executing the work, and the work (processing) time or the like.

The due date is information that represents the time limit for the completion of all the jobs (processes) to be executed using the document.

The terminal device 4 transmits, to the management server 2, a document publishing request that requests the generation and management of a document based on the document publishing information inputted by the user. The management server 2 receives the document publishing request from the terminal device 4 via the network 6. The management server 2 generates document management information based on the document publishing request from the terminal device 4 and stores (registers) the document management generated information in the memory unit 73.

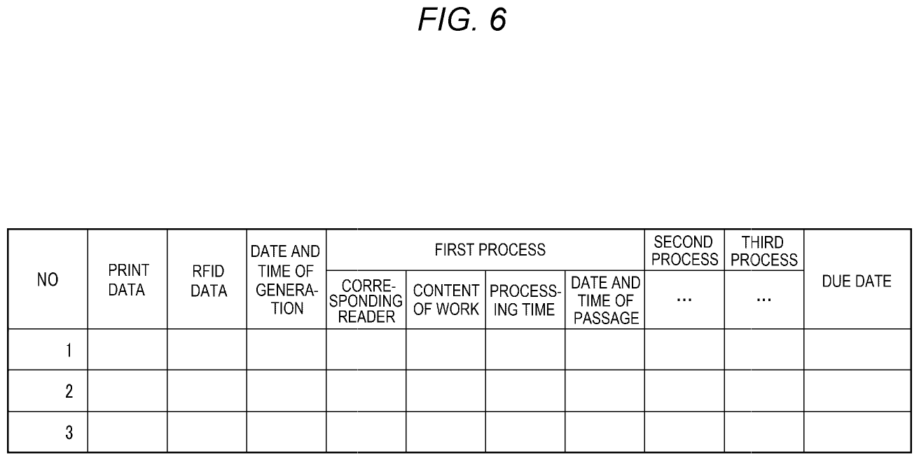

FIG. 6 shows an example of the document management information registered in the memory unit 73 by the management server 2 according to the embodiment.

In the example shown in FIG. 6, the management server 2 registers a plurality of pieces of document management information on a per management number basis. The management server 2 gives a management number to document management information for each individual document to be generated and stores the document management information in the memory unit 73. Each piece of document management information includes print data, RFID data, date and time of generation, one or a plurality of pieces of job (first, second, third process) information, and due date. As the document management information, information that represents the destination of notification (predetermined destination of notification) to be notified of information about the management of the document such as the terminal device used by the user publishing the document or by the manager is registered other than the information shown in FIG. 6.

The print data in the document management information is data to print, on a medium, an image as a written document of the document generated by the digital multi-functional peripheral 3 in response to the document publishing request from the terminal device 4.

The RFID data in the document management information is data to be written to the RFID tag on the medium S generated as the document by the digital multi-functional peripheral 3 in response to the document publishing request from the terminal device 4. The RFID data may be data designated by a document generation request or may be data that is automatically allocated (generated) by the management server 2 (or the digital multi-functional peripheral 3), based on a predetermined rule.

The date and time of generation in the document management information is information that represents the date and time when the document to be managed is generated in response to the document publishing request from the terminal device 4. The management server 2 acquires information that represents the date and time when the generation of the document is completed, from the digital multi-functional peripheral 3. The management server 2 registers the date and time when the generation of the document is completed, which is acquired from the digital multi-functional peripheral 3, as the date and time of generation in the document management information.

The job (process) information in the document management information is information that represents the content and the status of execution, of the work (or processing) to be executed using the document. A plurality of pieces of job information may be provided for one document. An order of execution may be designated for the plurality of pieces of job information. The plurality of pieces of job information for which an order of execution is designated are registered as job (process) information in the order of execution. In the example shown in FIG. 6, three jobs (processes) are registered as a first process, a second process, and a third process.

In the example shown in FIG. 6, as each piece of job information (information about each process) in the document management information, information such as corresponding reader, content of work, processing time, and date and time of passage is registered.

The corresponding reader of each process is information that represents an RFID reader that reads the RFID tag of the document in the case of executing the job (process). For example, the corresponding reader of the first process is information that represents an RFID reader installed at a place where the work of the first process is executed. However, the RFID reader as the corresponding reader may be a handheld reader or the like connected to the user terminal of the worker who executes the job.

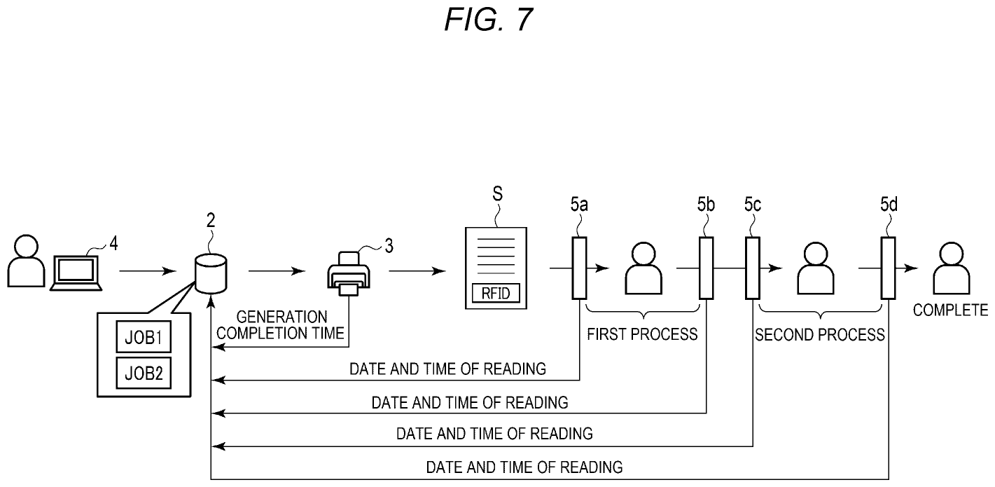

As the corresponding reader, a reader that reads the RFID tag of the document before the execution of the job (process) and a reader that reads the RFID tag after the execution of the job may be set. For example, in the case of application examples shown in FIGS. 7 to 9, described later, an RFID reader 5a may be registered as a reader that reads the RFID tag of the document S at the time of the start of the first process (entry to the first process) (reader at the start time). An RFID reader 5b shown in FIGS. 7 to 9 may be registered as a reader that reads the RFID tag of the document S at the time of the end of the first process (exit from the first process) (reader at the end time).

The content of work of each process is information that represents the content of work or processing to be executed as the job (process). For example, the content of work may be information that represents work to be given a mark (stamp or signature or the like) indicating that a designated approver (worker) has approved (confirmed) the document.

The content of work may also include information that represents a worker (user terminal of the worker) to whom the content of work is reported. In this case, if the corresponding reader for one process reads the RFID tag of the document, the management server 2 may report a guidance on the content of work to the user terminal of the worker for this process.

The processing time of each process is information that represents the time required for the work of the job (process). The processing time may be the time indicating the time limit of execution of the work of the job. If the processing time as the time limit of execution is registered, the management server 2 notifies the user or the manager that the work is yet to be executed, when the time limit of execution indicated by the processing time is passed. The processing time may also be the time (execution time) required for the completion after the start of the work of each job (process). In this case, the management server 2 may notify the user or the manager of an alert to the effect that the work is yet to be executed, unless the work is finished within the processing time after the start of the work.

The date and time of passage in each process is information that represents the date and time when the corresponding reader of the job (process) reads the RFID tag of the document. If the reader at the start time and the reader at the end time are registered as the job (process) information, the date and time of the start of the job and the date and time of the end of the job may be registered as the date and time of passage. For example, the document management information stores the date and time when the RFID reader registered as the reader at the start time reads the RFID tag, as the date and time of the start. The document management information also stores the date and time when the RFID reader registered as the reader at the end time reads the RFID tag, as the date and time of the end.

The due date in the document management information is information that represents the time limit for the completion of all the registered jobs (processes). The due date may be information that represents the time limit in relation to the time elapsed from the date and time of generation, or may be a predetermined date and time. The management server 2 outputs an alert indicating that the due date is passed, to the user or the manager, if all the jobs registered as the document management information are not completed by the due date.

A first application example as an operation example of the document management system 1 according to the embodiment will now be described.

FIG. 7 explains the first application example as an operation example of the document management system 1 according to the embodiment.

The user inputs document publishing information including information to be recorded on a document generated by the digital multi-functional peripheral 3 and the content of a job (processing or work) to be executed using the document, or the like, to the terminal device 4. The document publishing information includes information such as print data, RFID data, job (process) information, and due date, as described above. The terminal device 4 transmits a document publishing request that requests the publishing and management of a document based on the document publishing information inputted by the user, to the management server 2.

The management server 2 receives the document publishing request from the terminal device 4 via the network 6. The management server 2 generates document management information corresponding to the document to be generated in response to the document publishing request from the terminal device 4. For example, the processor 71 of the management server 2 generates the document management information as shown in FIG. 6, based on the document publishing request. The processor 71 of the management server 2 stores (registers) the generated document management information in the memory unit 73.

After registering the document management information, the management server 2 requests the digital multi-functional peripheral 3 to generate the document to be managed based on the document management information. For example, the management server 2 transmits, to the digital multi-functional peripheral 3, a generation (print) command including print data to print on the medium S generated as the document and data to be written to the RFID tag provided on the medium S.

The digital multi-functional peripheral 3 generates the document S, using a medium with an RFID tag, in response to the generation command from the management server 2. The digital multi-functional peripheral 3 prints the print data included in the generation command onto the medium S, by the printer 13, and writes the RFID data included in the generation command to the RFID tag on the medium S, by the RFID device 16. The digital multi-functional peripheral 3 may execute the generation of the document which the user gives an instruction to publish, if the authentication of the user requesting the this When publishing of document is successful. the generation of the document is complete, the digital multi-functional peripheral 3 transmits a notification of the completion of the generation of the document and the date and time of the completion of the generation of the document to the management server 2.

The management server 2 waits for the notification of the completion of the generation of the document from the digital multi-functional peripheral 3, after transmitting the generation command for the document to the digital multi-functional peripheral 3. The management server 2 receives the notification of the completion of the generation of the document and the information that represents the date and time of the completion of the generation of the document from the digital multi-functional peripheral 3. The management server 2 records (registers) the date and time of the completion of the generation of the document received from the digital multi-functional peripheral 3, as the date and time of generation of this document in the document management information.

After registering the date and time of generation of the document (after the document is completed), the management server 2 collects information that represents the date and time when each RFID reader 5 reads the RFID tag of the document. The management server 2 receives reading information including the date and time of reading when the RFID reader 5 reads the RFID tag of the document to be managed, and then records (registers) the received date and time of reading as the document management information.

For example, the management server 2 acquires the reading information of the RFID tag from each RFID reader 5. The management server 2 specifies the date and time of reading when the RFID tag of the document to be managed is read, from the reading information acquired from each RFID reader. For example, the management server 2 specifies the date and time of reading when the RFID reader that is the corresponding reader of each job (process) reads the RFID tag of the document to be managed.

The management server 2 may also designate the data of the RFID tag of the document to be managed, to the RFID reader 5 that is the corresponding reader of each job (process). In this case, the RFID reader 5 transmits, to the management server 2, the date and time of reading when the RFID reader 5 reads the data of the RFID tag of the document to be managed that is designated by the management server 2. The management server 2 may thus acquire the date and time of reading when the RFID reader 5 reads the RFID tag of the document to be managed.

The document as the medium S having the RFID tag that is generated by the digital multi-functional peripheral 3 is transported by the worker to the place where the first process is executed. In the example shown in FIG. 7, the corresponding reader of the first process is the RFID reader 5a and the RFID reader 5b. Therefore, in the document management information of the document S, the RFID reader 5a and the RFID reader 5b are registered as the corresponding reader of the first process.

The RFID reader 5a, which is the corresponding reader of the first process, reads the RFID tag of the document (medium) S and then transmits information that represents the date and time of reading to the management server 2. The RFID reader 5b, which is the corresponding reader of the first process, reads the RFID tag of the document S and then transmits information that represents the date and time of reading to the management server 2. The management server 2 receives the information that represents the date and time of reading from the RFID reader 5a or 5b and then registers the received date and time of reading as the date and time of passage in the first process in the document management information. Thus, the date and time of passage in the first process is registered in the document management information of the document S.

The document management information of the document S may set a reader that reads the RFID tag at the time of the start of (or entry to) the first process and a reader that reads the RFID tag at the time of the end of (or exit from) the first process. In the case of the application shown in FIG. 7, the RFID reader 5a may be set as the reader that reads the RFID tag of the document S at the time of the start of the first process. In this case, the management server 2 may register the date and time of reading when the RFID reader 5a reads the RFID tag of the document S as the date and time of the start of (or the date and time of entry to) the first process in the document management information.

The RFID reader 5b may be set as the reader that reads the RFID tag of the document S at the time of the end of the first process (exit from the first process). In this case, the management server 2 may register the date and time of reading when the RFID reader 5b reads the RFID tag of the document S as the date and time of the end of the first process in the document management information. Thus, in the document management information of the document S, the date and time of the start and the date and time of the end of the first process can be registered as the date and time of passage in the first process.

The document (medium) S finished with the first process is transported to the second process by the worker. In the example shown in FIG. 7, the corresponding reader of the second process is an RFID reader 5c and an RFID reader 5d. Therefore, in the document management information of the document S, the RFID reader 5c and the RFID reader 5d are registered as the corresponding reader of the second process.

The RFID reader 5c or 5d, which is the corresponding reader of the second process, reads the RFID tag of the document S and then transmits information that represents the date and time of reading to the management server 2. The management server 2 receives the information that represents the date and time of reading from the RFID reader 5c or 5d and then registers the received date and time of reading as the date and time of passage in the second process in the document management information. Thus, the date and time of passage in the second process is registered in the document management information of the document S.

In the case of the application shown in FIG. 7, the RFID reader 5c may be set as the reader that reads the RFID tag of the document S at the time of the start of the second process (entry to the second process). In this case, the management server 2 may register the date and time of reading when the RFID reader 5c reads the RFID tag of the document S as the date and time of the start of (or the date and time of entry to) the second process in the document management information.

The RFID reader 5d may be set as the reader that reads the RFID tag of the document S at the time of the end of the second process (exit from the second process). In this case, the management server 2 may register the date and time of reading when the RFID reader 5d reads the RFID tag of the document S as the date and time of the end of the second process in the document management information. Thus, in the document management information of the document S, the date and time of the start and the date and time of the end of the second process can be registered as the date and time of passage in the second process.

If the processes (jobs) registered in the document management information include up to the second process, the management server 2 determines that all the jobs (processes) for the document S are finished, when the second process is finished. In the example shown in FIG. 7, the management server 2 determines that all the processes up to the second process are finished, if the RFID reader 5d reads the RFID tag of the document S. In this case, the management server 2 may register the date and time of reading of the RFID tag of the document S received from the RFID reader 5d, as the date and time of the end of all the processes in the document management information. If the management server 2 determines that all the processes are finished, the management server 2 may delete this document management information from the memory or may disable this document management information.

The management server 2 may also give various notifications to the user or the manager, based on the document management information. The management server 2 notifies a user registered in advance or the manager of various information that represents the status of management of the document based on the document management information, using a contact method such as email or chat.

For example, if there is a process yet to be executed for the document S even when the due date is passed (if the due date is passed), the management server 2 notifies the user or the manager or the like that the due date is passed. Also, if the date and time of passage of the document S is not registered even when the processing time is passed (if the processing time is passed), the management server 2 may notify the user or the manager or the like of the process yet to be executed. Moreover, if the date and time of passage (or the date and time of the start and the date and time of the end) in each process is registered, the management server 2 may notify the user who is the generator of the document, or the manager, of information that represents the status of progress (status of execution) of each process.

A second application example as an operation example of the document management system 1 according to the embodiment will now be described.

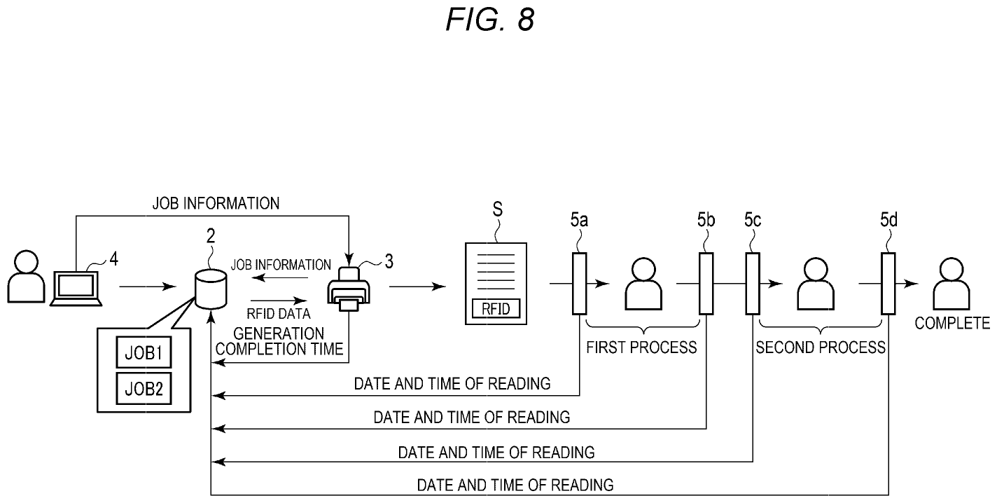

FIG. 8 explains the second application example as an operation example of the document management system 1 according to the embodiment.

First, the user inputs document publishing information including print data, RFID data, job information, and due date to the terminal device 4, as in the foregoing first application example. In the second application example shown in FIG. 8, the terminal device 4 transmits a document publishing request that requests the publishing and management of a document based on the document publishing information inputted by the user, to the digital multi-functional peripheral 3. The digital multi-functional peripheral 3 stores the document publishing request received from the terminal device 4, in the memory 51, and transmits a registration request for document management information to the management server 2.

The management server 2 receives the registration request for document management information from the digital multi-functional peripheral 3. The management server 2 generates document management information in response to the registration request for document management information based on the document publishing request received from the digital multi-functional peripheral 3, the same as in the first application example. The management server 2 stores (registers) the generated document management information in the memory unit 73 and waits for a notification of the completion of the generation of the document from the digital multi-functional peripheral 3.

The digital multi-functional peripheral 3 executes the generation of the document based on the print data and the RFID data included in the document publishing request from the terminal device 4. The digital multi-functional peripheral 3 prints an image of a written document on the medium S, by the printer, and writes the RFID data to the RFID tag on the medium S with the image printed thereon, by the RFID device. However, the RFID data may be acquired from the management server 2 generating the document management information or may be generated by the digital multi-functional peripheral 3. When the generation of the document is complete, the digital multi-functional peripheral 3 notifies the management server 2 of the completion of the generation of the document and the date and time of generation of the document.

The digital multi-functional peripheral 3 may acquire data to be written to the RFID tag of the document S from the management server 2 generating the document management information. In this case, the management server 2 may generate RFID data to be written to the RFID tag of the document according to a predetermined rule and may transmit the generated RFID data to the digital multi-functional peripheral 3. Also, the digital multi-functional peripheral 3 may generate RFID data to be written to the RFID tag of the document according to a predetermined rule and may notify the management server 2 of the generated RFID data.

In the second application example shown in FIG. 8, the operation after the digital multi-functional peripheral 3 generates the document is similar to the operation in the foregoing first application example shown in FIG. 7. That is, the management server 2 registers the date and time of generation from the digital multi-functional peripheral 3 and subsequently collects the date and time of reading when each RFID reader 5 reads the RFID tag of the document, and updates the document management information.

A third application example as an operation example of the document management system 1 according to the embodiment will now be described.

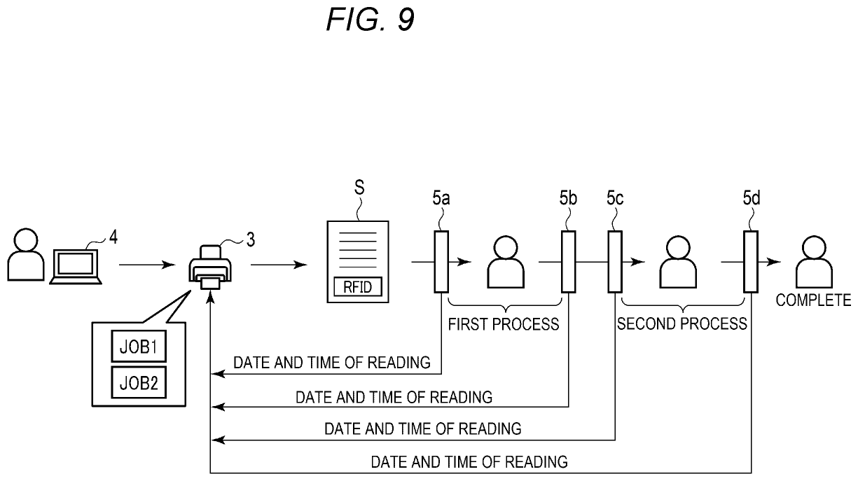

FIG. 9 explains the third application example as an operation example of the document management system 1 according to the embodiment.

In the third application example shown in FIG. 9, the digital multi-functional peripheral 3 performs the operation of the management server 2 described in the first or second application example. The third application example shown in FIG. 9 is executed in the document management system 1 formed of the digital multi-functional peripheral 3 configured to operate as the management server 2, and the terminal device 4 and RFID reader 5.

The user inputs document publishing information including print data, RFID data, job information, and due date to the terminal device 4. The terminal device 4 transmits a document publishing request that requests the publishing and management of a document based on the document publishing information inputted by the user, to the digital multi-functional peripheral 3.

The digital multi-functional peripheral 3 receives the document publishing request from the terminal device 4. The digital multi-functional peripheral 3 generates document management information based on the document publishing request received from the terminal device 4. The digital multi-functional peripheral 3 stores (registers) the document management information generated based on the document publishing request, in the memory device 54.

After registering the document management information, the digital multi-functional peripheral 3 generates the document S, using a medium having an RFID tag, based on the print data and the RFID data included in the document publishing request. The digital multi-functional peripheral 3 may generate RFID data to be written to the RFID tag of the generated document, according to a predetermined rule.

When the generation of the document is complete, the digital multi-functional peripheral 3 registers the date and time of generation of the document into the document management information registered in the memory device 54. After generating the document, the digital multi-functional peripheral 3 operates similarly to the management server 2 described in the first or second application example. That is, after registering the date and time of generation, the digital multi-functional peripheral 3 collects the date and time of reading when the RFID reader 5 reads the RFID tag of the document, and updates the document management information.

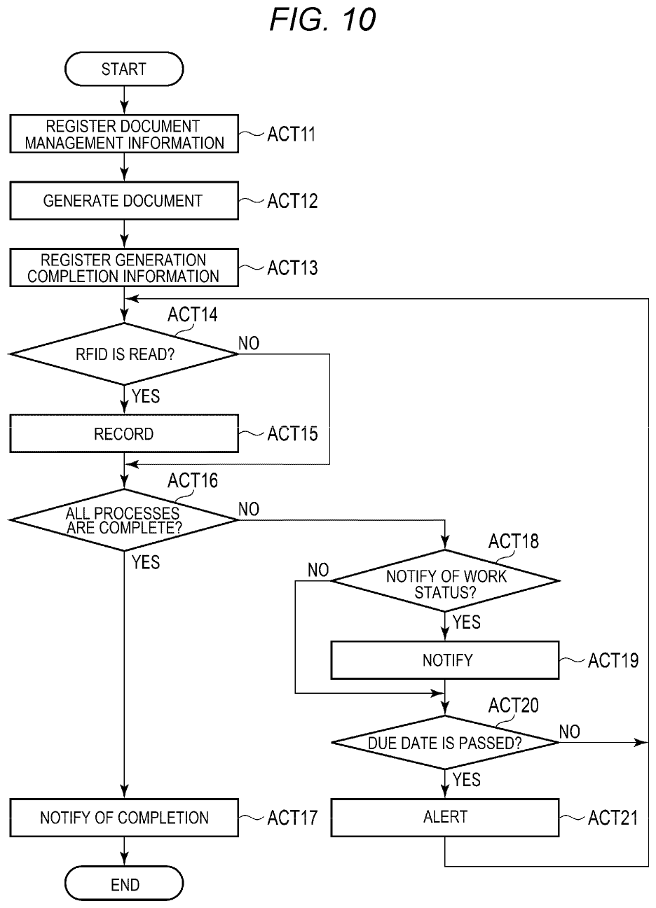

Management processing by the management server 2 of the document management information for a document with an RFID tag generated by the digital multi-functional peripheral 3 according to the embodiment will now be described. FIG. 10 is a flowchart for explaining an operation example of the management processing by the management server 2 for a document with an RFID tag generated by the digital multi-functional peripheral 3 according to the embodiment.

First, the user inputs, to the terminal device 4, information such as print data, RFID data, job information, and due date as document publishing information to publish a document. The terminal device 4 transmits a document publishing request that requests the publishing and management of a document based on the document publishing information inputted by the user, to the management server 2 or the digital multi-functional peripheral 3.

The management server 2 receives the document publishing request from the terminal device 4 via the network 6 by the communication unit 74. The processor 71 of the management server 2 generates document management information based on the document publishing request received from the terminal device 4 and stores (registers) the generated document management information in the memory unit 73 (ACT 11). For example, the processor 71 generates the document management information as shown in FIG. 6 described above and stores the document management information in the memory unit 73.

After registering the document management information, the processor 71 of the management server 2 causes the digital multi-functional peripheral 3 to generate a document to be managed based on the document management information (ACT 12). The processor 71 transmits a generation command for a document including print data and RFID data registered as the document management information to the digital multi-functional peripheral 3 by the communication unit 74.

The digital multi-functional peripheral 3 receives the generation command for the document from the management server 2 by the communication interface 55 of the system control unit 15. The processor 50 of the system control unit 15 of the digital multi-functional peripheral 3 prints an image (written document) based on the print data included in the generation command for the document, on a medium with an RFID tag by the printer 13. Also, the processor 50 writes the RFID data included in the generation command for the document, by the RFID device 16, to the RFID tag on the medium on which the printer 13 prints the image. When the printing of the written document on the medium with the RFID tag and the writing of the RFID data are complete, the processor 50 transmits a notification of the completion of the generation of the document and the date and time of generation to the management server 2.

The processor 71 of the management server 2, after transmitting the generation command for the document, receives the notification of the completion of the generation of the document from the digital multi-functional peripheral 3 by the communication unit 74. The processor 71 receives the information that represents the date and time of generation of the document along with the notification of the completion of the generation of the document from the digital multi-functional peripheral 3 by the communication unit 74. When the processor 71 has received the date and time of generation of the document, the processor 71 registers (records) the received date and time of generation of the document in the document management information (ACT 13).

The processor 71 of the management server 2, after receiving the notification of the completion of the generation of the document, collects reading information including the date and time when each RFID reader 5 reads the RFID tag of the document. When each RFID reader 5 has read the RFID tag of the document, each RFID reader 5 notifies the management server 2 of the result of reading (reading information) including the date and time of reading of the RFID tag.

The processor 71 of the management server 2 receives the result of reading of the RFID tag from the RFID reader 5 and then determines whether the received result of reading is the result of reading of the RFID tag of the document to be managed. If the processor 71 has received the reading information of the RFID tag of the document to be managed (YES in ACT 14), the processor 71 records the date and time of reading included in the received reading information, into the document management information (ACT 15). The processor 71 specifies the job (process) in the document management information corresponding to the RFID reader 5 that is the source of transmission of the reading information (that has read the RFID tag). After specifying the process corresponding to the RFID reader, the processor 71 registers the date and time of reading when the RFID reader 5 reads the RFID tag, as the date and time of passage of the document in this process.

In the example shown in FIG. 7, the management server 2 registers the date and time of reading when the RFID reader 5a or 5b reads the RFID tag of the document S, as the date and time of passage in the first process in the document management information. Also, in the example shown in FIG. 7, the management server 2 may register the date and time of reading when the RFID reader 5a reads the RFID tag of the document S, as the date and time of entry to (date and time of the start of) the first process in the document management information. The management server 2 may also register the date and time of reading when the RFID reader 5b reads the RFID tag of the document S, as the date and time of exit from (date and time of the end of) the first process.

If the processor 71 records the date and time of reading of the RFID tag or if no RFID tag is read, the processor 71 determines whether all the jobs (processes) in the document management information are complete (ACT 16). If all the processes are complete (YES in ACT 16), the processor 71 notifies a predetermined destination of notification (the user who is the publisher of the document or the manager) that all the jobs for the document are complete (ACT 17).

If all the processes s in the document management information are complete (YES in ACT 16), the processor 71 determines whether to notify of the work status represented by the document management information (ACT 18). The processor 71 may determine whether to notify of the work status, based on whether the document management information is updated. For example, if the date and time of reading (date and time of passage) is recorded in one of the processes in the document management information, the processor 71 determines that a notification of the work status of the process in which the date and time of reading is recorded is to be given.

The processor 71 may also determine whether to give such a notification, based on whether the processing time (time limit of execution) of each process is passed in a yet-to-be-executed state in the document management information. In this case, if there is a yet-to-be-executed process whose time limit of execution is passed, the processor 71 determines that a notification of the work status (yet-to-be-executed process) is to be given. The processor 71 may also store notification setting information about the work status in correlation with the document management information, in the memory unit 73. In this case, the processor 71 determines whether to notify of the work status represented by the document management information, in accordance with the notification setting information.

If it is determined that a notification of the work status is to be given (YES in ACT 18), the processor 71 notifies the user or the manager that is a predetermined destination of notification, of the work status represented by the document management information (ACT 19). For example, if the date and time of reading (date and time of passage) is recorded in one of the processes in the document management information, the processor 71 notifies the predetermined destination of notification, of the work status of the process in which the date and time of reading is recorded. Also, if there is a yet-to-be-executed process whose time limit of execution is passed, the processor 71 notifies predetermined destination of notification, of the process whose time limit of execution is passed in the yet-to-be-executed state.

If the processor 71 determines that a notification of the work status is not to be given (NO in ACT 18) or if the processor 71 has notified of the work status, the processor 71 determines whether the due date in the document management information is passed (ACT 20). If the due date in the document management information is passed (YES in ACT 20), the processor 71 notifies the user or the manager that is the predetermined destination of notification, of an alert indicating that the due date is passed (ACT 21). If the due date in the document management information has not passed (NO in ACT 20), the processor 71 returns to ACT 14 and executes the foregoing processing.

As described above, the management server according to the embodiment stores, in the memory, document management information including job information that represents a job to be executed using a document with an RFID tag generated by the image forming device. The management server updates information that represents the work status of the job represented by the job information in the document management information, based on reading information of the RFID tag by the reader device corresponding to the job information in the document management information.

Thus, according to the embodiment, not only the management of a document having an RFID tag but also the management of a job using the document having the RFID tag, or the like, can be executed collectively. Also, according to the embodiment, the work status of the job using the document having the RFID tag can be managed, based on the reading of the RFID tag of the document by the RFID reader.

The management server according to the embodiment can also notify a predetermined destination of notification, of the work status of the job represented by the job information in the document management information stored in the memory. Thus, according to the embodiment, the status of the job using the document having the RFID tag can be suitably reported to the user or the manager or the like.

Moreover, if the due date is passed without the completion of all the jobs in the document management information, the management server can notify the predetermined destination of notification that the due date of the document is passed. Thus, according to the embodiment, the user or the manager can be prompted to take some measures for the document whose due date is passed and the job using the document.

While some embodiments of the present disclosure have been described, these embodiments are presented simply as examples and are not intended to limit the scope of the present disclosure. These novel embodiments can be implemented in various other forms and can include various omissions, replacements, and changes without departing from the spirit and scope of the present disclosure. These embodiments and modifications thereof are included in the spirit and scope of the present disclosure and also included in the scope of the claims and equivalents thereof.

What is claimed is:

1. A management server comprising:
a communication interface configured to communicate with
an image forming device comprising (i) a printer configured to print an image on a medium and (ii) a reader-writer configured to write data to an electronic device disposed on the medium, and
a reader configured to read the data from the electronic device;
a memory configured to store document management information including job information that represents a job executed using a document whose data is written by the reader-writer to the electronic device disposed on the medium on which the image is printed by the printer in the image forming device; and
a processor configured to update information that represents a work status of the job represented by the job information in the document management information, based on reading information of the electronic device disposed on the document by the reader.

2. The management server according to claim 1, wherein
the processor records a date and time of generation when the image forming devices generates the document, in the document management information.

3. The management server according to claim 1, wherein
the processor records a date and time of reading when the reader corresponding to the job represented by the job information in the document management information reads the electronic device of the document.

4. The management server according to claim 1, wherein
the communication interface is further configured to communicate with a terminal that is a predetermined destination of notification, and
the processor is configured to notify the predetermined destination of notification, of the work status of the job represented by the job information in the document management information.

5. The management server according to claim 1, wherein
the communication interface is further configured to communicate with a terminal that is a predetermined destination of notification, and
when a due date is passed without completion of all jobs represented by the job information in the document management information, the processor notifies the predetermined destination of notification that the due date of the document is passed.

6. An image forming device comprising:
a printer configured to print an image on a medium;
a reader-writer configured to write data to an electronic device provided on the medium;
a memory configured to store document management information including job information about a job executed using a document whose data is written by the reader-writer to the electronic device disposed on the medium on which the image is printed by the printer;
a communication interface configured to:
communicate with a reader that corresponds to the job represented by the job information in the document management information and
read the electronic device disposed on the document; and
a processor configured to update information that represents a work status of the job represented by the job information in the document management information, based on reading information of the electronic device provided on the document by the reader.

7. A method of operating a management server, the management server comprising a communication interface configured to communicate with an image forming device comprising (i) a printer configured to print an image on a medium and (ii) a reader-writer configured to write data to an electronic device disposed on the medium, and a reader configured to read the data from the electronic device, the method comprising:
storing document management information including job information that represents a job executed using a document whose data is written by the reader-writer to the electronic device disposed on the medium on which the image is printed by the printer in the image forming device; and
updating information that represents a work status of the job represented by the job information in the document management information, based on reading information of the electronic device disposed on the document by the reader.

8. The method according to claim 7, further comprising recording a date and time of generation when the image forming devices generates the document, in the document management information.

9. The method according to claim 7, further comprising recording a date and time of reading when the reader corresponding to the job represented by the job information in the document management information reads the electronic device of the document.

10. The method according to claim 7, further comprising communicating with a terminal that is a predetermined destination of notification, and
notifying the predetermined destination of notification, of the work status of the job represented by the job information in the document management information.

11. The method according to claim 7, further comprising:
communicating with a terminal that is a predetermined destination of notification, and
when a due date is passed without completion of all jobs represented by the job information in the document management information, notifying the predetermined destination that the due date of the document is passed.

12. A method of operating an image forming device, the image forming device comprising a printer configured to print an image on a medium; and a reader-writer configured to write data to an electronic device provided on the medium,
the method comprising:
storing document management information including job information about a job executed using a document whose data is written by the reader-writer to the electronic device disposed on the medium on which the image is printed by the printer;
communicating with a reader that corresponds to the job represented by the job information in the document management information;
reading the electronic device disposed on the document; and
updating information that represents a work status of the job represented by the job information in the document management information, based on reading information of the electronic device provided on the document by the reader.
